(19) United States
(12) Patent Application Publication
(10) Pub. No.: US 2016/0153488 A1
(43) Pub. Date: Jun. 2, 2016

(54) ARTICLE HOLDERS AND ARTICLES COMPRISING SAME

(71) Applicant: Lup Chee NG, Hong Kong (CN)

(72) Inventor: Lup Chee NG, Hong Kong (CN)

(21) Appl. No.: 14/906,566

(22) PCT Filed: Jul. 30, 2014
(86) PCT No.: PCT/IB2014/063540

§ 371 Date: Jan. 21, 2016

(30) Foreign Application Priority Data
Aug. 1, 2013 (HK) 13108994.4

(51) Int. Cl. F16B 47/00; A47G 23/02; F16M 13/02

(52) U.S. Cl. CPC F16B 47/00; F16M 13/022; A47G 23/0225

(57) ABSTRACT

An article holder (100) comprises a first end (110), a second end (120), and a peripheral portion (130) interconnecting the first end and the second end, wherein the first end is for attaching to a support surface to form a first air-tight end, the second end is for attaching to a surface of an article to form a second air-tight end, and the peripheral portion is to form an air-tight chamber in cooperation with the first and second air-tight ends during use; and wherein the peripheral portion is deformable to expel air from the air-tight chamber through an air exit arrangement on the peripheral portion to form a low-pressure region inside the air-tight chamber to facilitate suctioned attachment of the article to the support surface via the article holder.

### FIELD

The present disclosure relates to article holders, and more particularly to article holders for holding articles on a smooth surface. This disclosure also relates to articles having a base for temporary or detachably attaching to a smooth surface.

### BACKGROUND

Many support surfaces such as table tops or bench tops are highly polished and are very smooth. While smooth surfaces are aesthetic and visually pleasing, articles placed on a smooth surface tend to slide when the smooth surface moves or tilts. For example, containers filled with food or beverages and placed on table top of moving vehicles may slide relative to the table top and result in spilling or toppling when the vehicles move or tilts.

Therefore, it will be advantageous if article holders can be provided to hold articles on a smooth surface to mitigate inconveniences or nuisance.

### SUMMARY

There is provided an article holder comprising a first end, a second end, and a peripheral portion interconnecting the first end and the second end, wherein the first end is for attaching to a support surface to form a first air-tight end, the second end is for attaching to a surface of an article to form a second air-tight end, and the peripheral portion is to form an air-tight chamber in cooperation with the first and second air-tight ends during use; and wherein the peripheral portion is deformable to expel air from the air-tight chamber thorough an air exit arrangement on the peripheral portion to form a low-pressure region inside the air-tight chamber to facilitate suctioned attachment of the article to the support surface via the article holder.

There is also provided an article comprising a main body and a suction attachment device, wherein the suction attachment device comprises an attachment end for making suctioning attachment with a support surface and a peripheral portion interconnecting the attachment end and the main body, and wherein the suction attachment device is to form an air-tight chamber when in cooperation with the support surface during use, and the peripheral portion is deformable to expel air out of the air-tight chamber thorough an air exit arrangement on the peripheral portion to form a low pressure region inside the air-tight chamber to facilitate making of suctioning attachment with the support surface.

The suction attachment device may be releasable or detachable from the main body.

The article holder is advantageous in that it provides a simple, lightweight and portable solution to facilitate supported gripping of an article on a support surface as and when needed.

The supported gripping is facilitated by a gripping between the article and the article holder and a gripping between the article holder and the support source, and the gripping is facilitated by a single low pressure region inside a volume defined by the body portion.

### DESCRIPTION OF FIGURES

The disclosure will be described by way of non-limiting example with reference to the accompanying Figures, in which:

FIG. 1 is a perspective view of an article holder according to the present disclosure,

FIG. 1A is a first elevation view of the article holder of FIG. 1,

FIG. 1B is a second elevation view of the article holder of FIG. 1 taken from left side of FIG. 1,

FIG. 1C is a third elevation view of the article holder of FIG. 1 taken from right side of FIG. 1,

FIG. 1D is a fourth elevation view of the article holder of FIG. 1 taken from opposite side of FIG. 1,

FIG. 1E is a top plan view of the article holder of FIG. 1,

FIG. 1F is a bottom plane view of the article holder of FIG. 1,

FIG. 2 is a perspective view of the article holder of FIG. 1 showing section lines A-A, B-B, and C-C,

FIG. 2A is a schematic sectional view of the article holder along the section line A-A of FIG. 2,

FIG. 2B is a schematic sectional view of the article holder along the section line B-B of FIG. 2,

FIG. 2C is a schematic sectional view of the article holder along the section line C-C of FIG. 2,

FIG. 3A is an enlarged view of portion D of FIG. 1,

FIG. 3B is an enlarged view of portion E of FIG. 1,

FIG. 3C is an enlarged view of a non-return valve on FIG. 3A,

FIG. 3D is a schematic cross-sectional view of the non-return valve on FIG. 3C along the section line G-G,

FIG. 4 is a schematic diagram depicting an example disposable container of FIG. 4A in combination with an example article holder of FIG. 4B according to the disclosure, and

FIG. 5A is a schematic diagram depicting the combination of FIG. 4 prior to making suctioning engagement with a support surface,

FIG. 5B is a schematic diagram depicting axial compression of the article holder to make suctioning engagement with the support surface, and

FIG. 5C is a schematic diagram depicting axial expansion of the article holder to release the combination from suctioning engagement with the support surface.

### DESCRIPTION

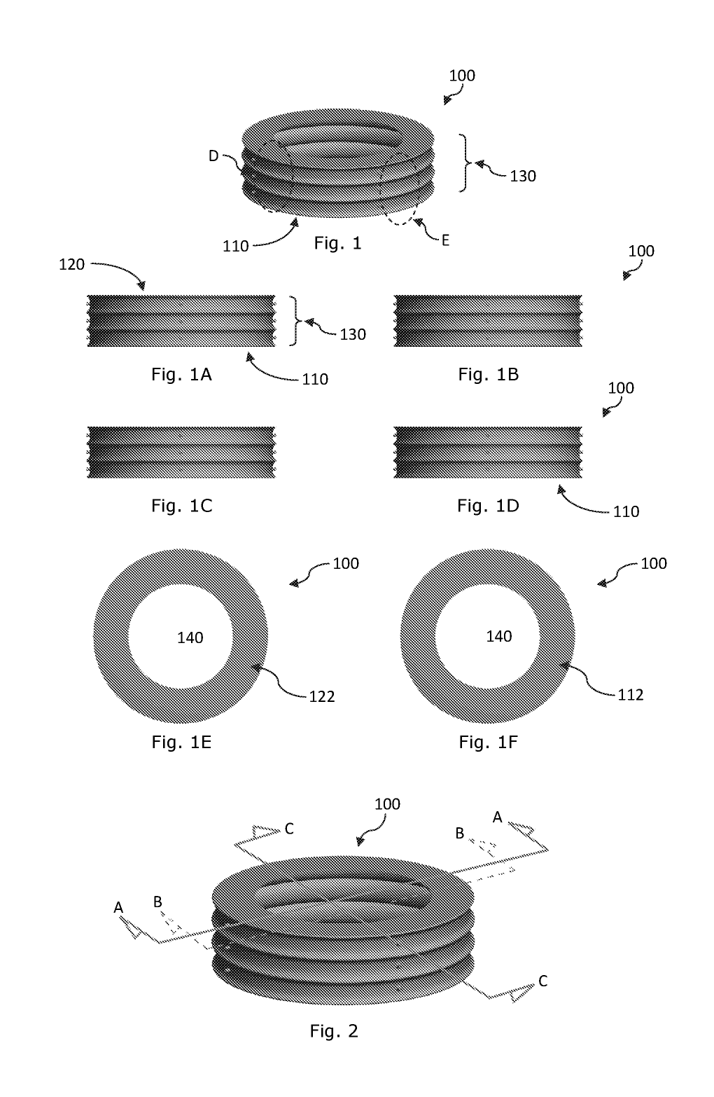

An article holder 100 depicted in FIGS. 1, 1A to 1F comprises a first end 110, a second end 120 and a peripheral portion 130 interconnecting the first and second ends. The first end 110, the second end 120 and the peripheral portion 130 collectively define a main body and an internal compartment 140 surrounded by the main body. The main body is substantially cylindrical and extends axially between the first end and the second end, such that the first and second ends are at the opposite cylindrical ends, and the cylindrical axis is at the centre of the first and second ends.

The peripheral portion 130 is resiliently deformable and is axially collapsible from its neutral state. When an axial compressive force is applied to one of the first and second axial ends while the other one of the first and second axial ends is supported on a rigid surface, the one end that is applied with the compressive force will retract towards the other end which is supported on the rigid surface. When the peripheral portion is axially compressed to collapse or retract, the volume of the hollow compartment 140 will reduce. Resilience of the peripheral portion will urge the peripheral portion 140 to return towards its neutral or expanded state.

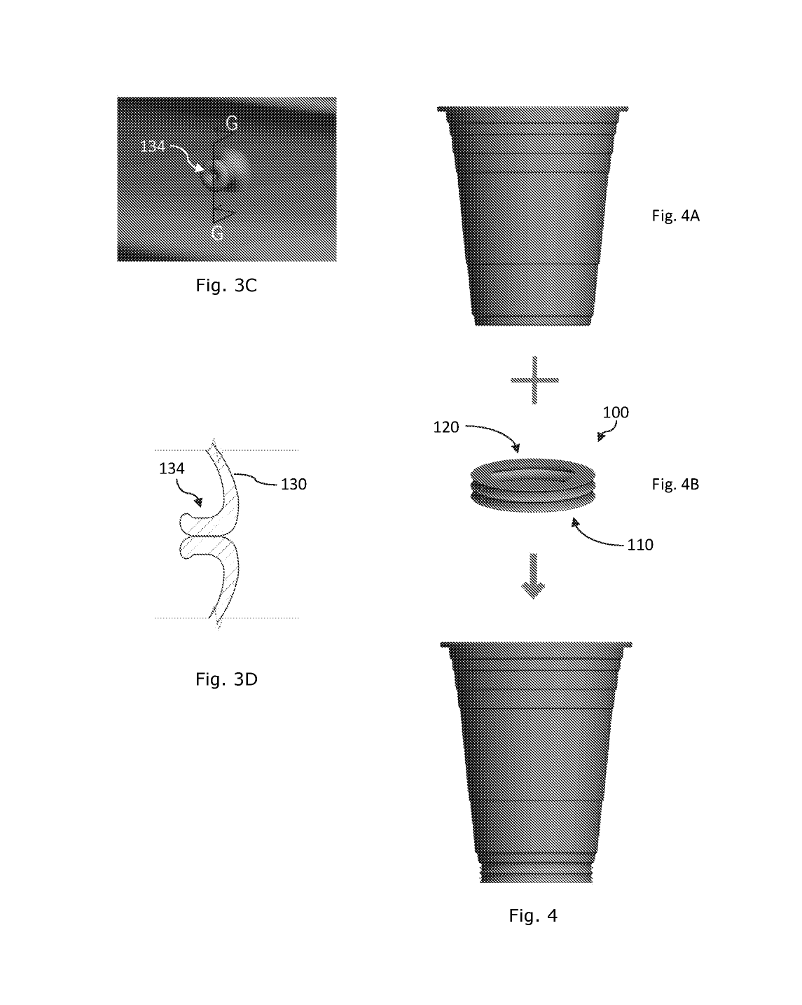

As depicted in FIGS. 1, 3A and 3B, a plurality of non-return valves 134 is distributed on the peripheral portion 130. The non-return valves 134 are provided on the peripheral portion 130 such that when the peripheral portion is axially compressed while both the first and second ends are air-sealed, air pressure inside the hollow compartment will increased portion above the atmospheric pressure and air inside the hollow compartment will escape from the hollow apartment through the valves due to pressure differences. As a result, a low pressure region or a partial vacuum is formed inside the sealed hollow compartment. The non-return valves, also known as one-way valves, provides an air exit path but restricts or prevents air from moving into the sealed hollow compartment. When the first and second ends are air-sealed, air-tight chamber is defined by the hollow compartment 140.

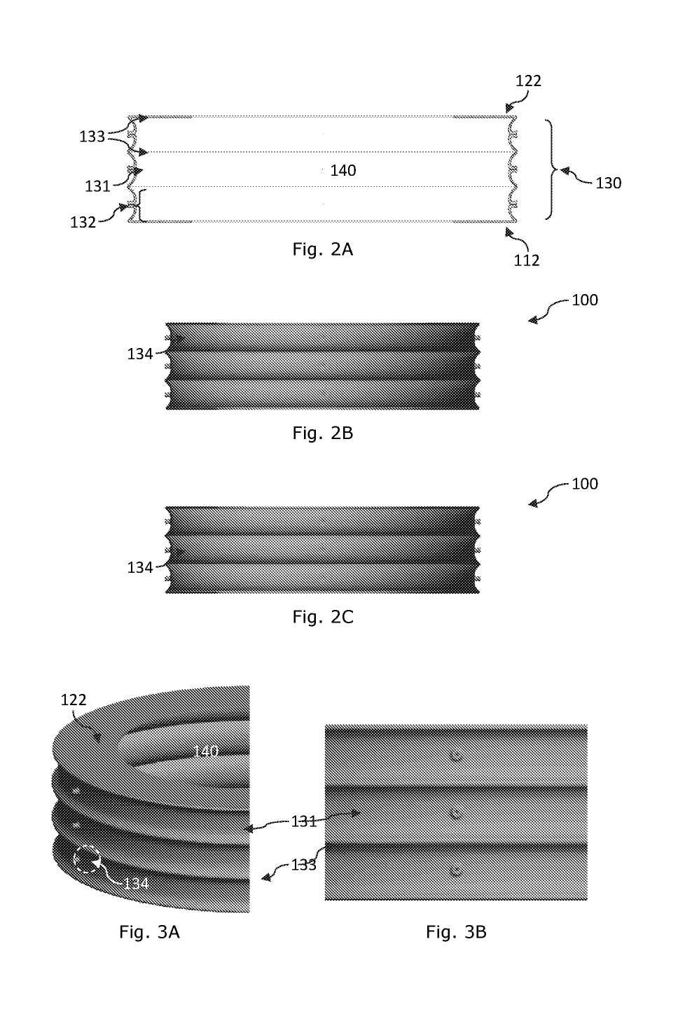

The peripheral portion 130 comprises a plurality of creased portions 132 forming a stack. As depicted in FIGS. 2, 2A to 2C, each of the creased portions 132 is defined by a circumferentially extending groove. The groove surrounds the hollow compartment 140 to define a crease plane that is orthogonal to the cylindrical axis. Each groove has a curved profile extending in the axial direction and defines a circumferentially extending depression 131 between two circumferentially extending rims 133. Adjacent circumferentially extending rims 133 are parallel and are at different axial levels. The maximum depth of the groove or the depression is at middle between the two circumferentially extending rims and the profile of the groove is symmetrical or substantially symmetrical about a plane defined by a line of maximum depression. The groove is opened in a direction which is away from the cylindrical axis. Therefore, the line of maximum depression is proximal or closest to the cylindrical axis while the circumferentially extending rims are distal or most distant from the cylindrical axis.

Adjacent creased portions 132 are vertically aligned and joined together to form a stack of aligned and continuous creased portions 132. The stacked creased portions 132 define at least a portion of the peripheral wall of the peripheral portion 130 that is collapsible. The creased portions 132 are joined together and collectively define a common axis which is the cylindrical axis of the cylindrical body defined by the stack of creased portions 132. The creased portions 132 have the same or identical dimensions in this example so that the peripheral wall has an overall substantially cylindrical shape with regular creased portion height. The term ‘creased portion height’ in the present context means the axial separation distance between adjacent groove defining rims.

The example article holder 100 is for holding an article onto a support surface so that the article does not inadvertently move relative to the support surface. The example article holder 100 is to form a suctioned grip with both the article and the support surface whereby the article is held onto the support surface. The suction grip is formed by a region of low pressure inside the air-tight chamber 140 and the formation of a low pressure air-tight chamber facilitates suction engagement between the article holder 100 and the article and between the article holder 100 and the support surface. In addition, the resilient peripheral portion 130 also operates to stabilise the article and liquid contents therein when the support surface is set into motion.

Suctioned gripping on the support surface is primarily facilitated by the formation of a low pressure region inside the hollow compartment 140 during normal use when the first end 110 is coupled in an air-tight manner to the support surface and the second end 120 is air-sealed by the contact surface of the article to be held. The low pressure region creates a suction which urges the second end towards the support surface to facilitate a friction grip of the second end on the support surface. The peripheral portion is preferably formed of a semi-rigid, non-porous and resilient material so that an air-tight chamber can be created upon expelling of air from the hollow compartment. The resilience of the material facilitates restoration of the peripheral portion to its pre-collapsed shape and configuration upon removal of the low pressure condition inside the hollow compartment so that the article holder can be repeatedly used. Soft plastics, rubber, silicone rubber, polypropylene or other resilient polymeric materials are example of suitable materials.

The first end 110 is formed at the lowermost axial end of the peripheral portion and includes a flange 112 which extends radially inwards and orthogonally towards the cylindrical axis. The radial flange overhangs the peripheral portion and forms an air-tight junction with the peripheral portion along its circumference. This radial flange defines a first end aperture which facilitates fluid communication between an article in contiguous contact with the second end and the hollow compartment. The first end aperture is substantially narrower than a compartment aperture defined by the groove of a creased portion due to narrowing by the radial flange.

The second end 120 is formed at the uppermost axial end of the peripheral portion and includes a flange 122 which extends radially inwards and orthogonally towards the cylindrical axis. The radial flange overhangs the peripheral portion and forms an air-tight junction with the peripheral portion along its circumference. This radial flange defines a first end aperture which facilitates fluid communication between an article in contiguous contact with the first end and the hollow compartment. The second end aperture is substantially narrower than a compartment aperture defined by the groove of a creased portion due to narrowing by the radial flange.

The radial flange 112, 122 of each of the first and second ends is adapted to operate as a sealing ring to enhance air-tight contact. More specifically, the radial flange of the first end is to enhance air-tightness between the article holder and the article to be held while the radial flange of the second end is to enhance air-tightness between the article holder and the support surface.

Therefore, the radial flange serves at least a dual purpose of narrowing an end aperture as well as enhancing air-tight sealing at the axial ends during use.

As depicted in more detail in FIGS. 2, and 2A to 2C, non-return valves, also known as one-way valves, are distributed on the peripheral portion 130 to provide an escape means for air kept inside the hollow compartment during normal use when both the axial ends of the article holder are air-sealed and the peripheral portion is to collapse axially under a compressive force. In this example, four non-return valves 134 are evenly distributed on the circumference of each of the creased portions and the non-return valves on adjacent creased portions are at the same circumferential location. Each of the non-return values is formed at the bottom of the groove where the curvature is at a minimum.

As depicted in FIGS. 3A to 3D, the non-return valve 134 is in the form of a stud member having an internal tunnel. The stud is made of a resilient material and projects radially away from the peripheral portion. The internal tunnel defines a controlled air-passage way which is inside the stud and extends between the hollow compartment and the outside ambient. The internal tunnel is shaped and dimensioned such that the passage way is collapsed to close unless the pressure inside the hollow compartment exceeds the ambient pressure outside by a predetermined threshold. When the pressure inside the hollow compartment exceeds the ambient pressure outside by a predetermined threshold, the internal pressure inside the hollow compartment will cause the tunnel to open and the air inside the hollow compartment will be driven out of the hollow apartment until the tunnel is closed.

In embodiments where the non-return valves 134 are integrally formed on the peripheral wall, thickness of the peripheral wall will be highest at the portion defining the non-return valves 134 and the thickness gradually decrease on moving away from the locations of the non-return valves. In an example, the thickness of the peripheral wall is about 0.3 mm at the non-return valves 134.

Each of the stud member projects radially outwards from the bottom of the groove. A radial outward projection of the non-return valves from the bottom of the groove is advantageous since the non-return valve, or at least a substantial portion of the non-return valve, is concealed by the axial projection of the adjacent groove defining rims or does not project beyond the axial projection of the adjacent groove defining rims. Such a disposition shields the non-return valve from inadvertent tampering as well as making the exterior surface of the article holder smoother.

In the example depicted FIG. 1, there are three creased portions of the same groove height stacked together having a total height of 12 mm, and four non-return valves are evenly distributed on the periphery of each groove. In addition, each creased portion has a creased portion width of about 4 mm, a groove wall thickness of 0.17 mm, a flange width of 10 mm, and a diameter of 50 mm across opposite diametric ends of the creased portion rims. In this example, the creased portion width is selected to be less than the typical width of a human finger such a stud forming a non-return valve will not be depressed by a finger during normal use. In some embodiments, the overall width of an article holder as defined by the transverse extent of the peripheral portion is larger or smaller than 50 mm. For example, the overall width can be 100 mm, 120 mm or more, or 50 mm or less.

In use, an article such as a food or beverage container depicted in FIG. 4A is to be placed on the article holder of FIG. 4B with the bottom surface aligned with the second end 120 of the article holder. When the article is urged against the article holder and a support surface on which the article holder is resting, air inside the air-tight chamber 140 will be driven out to form a low-pressure region and hence suctioned attachment as depicted in FIG. 4. After use, the article can be detached from the article holder for subsequent or other uses. When the suctioned attachment is to be released, a user may squeeze to deform the peripheral portion 130 so that outside air can move into the hollow compartment 140 through the first end or the second end to equalize the pressure difference and remove the gripping suction.

In some embodiments, the article holder is permanently attached to the article to form a combined article so that the second end of the article holder is air-sealed by the article, for example by bottom of the article. In such an example, the article holder will become a supporting base of the combined article with suctioned attachment means.

In some embodiments, no non-return valve is formed on the article holder. In such an example, air inside the hollow compartment is expelled through a junction or junctions, such as a junction between the article and the article holder, a junction between the support surface and the article holder, or a combination thereof. A partial vacuum or a low pressure region sufficient to create a friction grip on the support surface will be generated by the article holder when the resilience of the peripheral portion causes the axially compressed peripheral portion to expand axially towards its pre-compressed state. Likewise, a partial vacuum or a low pressure region sufficient to create a friction grip on the article will be generated when the resilience of the peripheral portion causes the axially compressed peripheral portion to expand axially towards its pre-compressed state where the article does not form a permanent air-tight connection with the article holder.

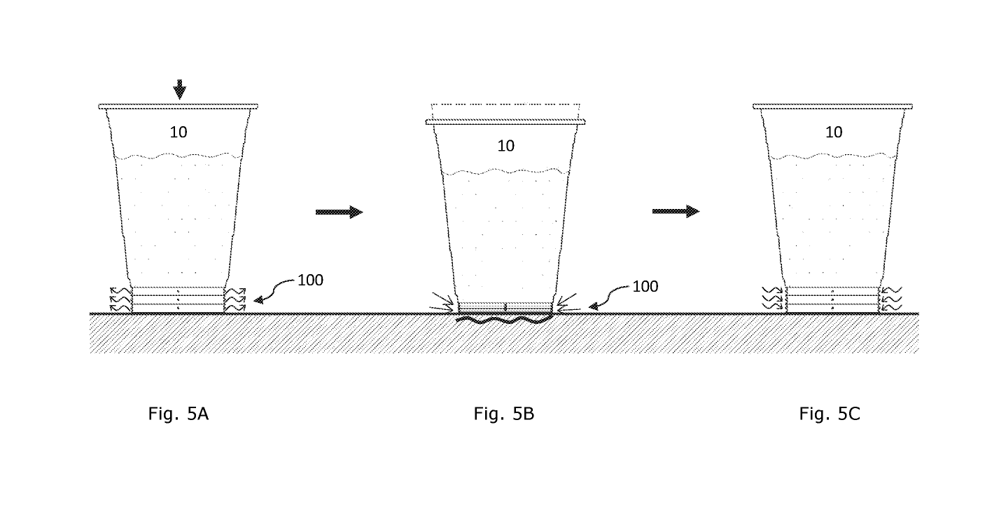

In an exemplary application of the article holder of FIG. 1 as depicted in FIG. 5A to 5C, the article holder is attached to the base of a beverage container 10 as an example article. In use, the article holder is to be placed on a support surface with is second end in contact with the bottom of a filled beverage container and its first end in contact with the support surface. After the article and the article holder are placed in engagement position, a user will apply an axial compressive force on the article holder. The axial compressive force can be applied on the article holder through the weight of the filled beverage container or directly. After air has been driven out of the hollow compartment, as schematically indicated by the curved arrows of FIG. 5A, the low pressure region inside the hollow compartment will produce a suction to adhere the article holder to frictionally grip on the support surface as depicted in FIG. 5B. At the same time, the low pressure region will also develop a suction which will cause the filled beverage container to be sucked towards the article holder. As a result, a stable yet temporary gripping of the filled beverage container on the support surface can be provided by the article holder. In this example, the article holder operates as support base and a suction base. The suction base may be integrated onto the article or as a detachable component without loss of generality.

When the suctioned attachment is to be released, a user may squeeze to deform the peripheral portion 130 of the article holder so that outside air can move into the hollow compartment 140 as schematically indicated by the curved arrows of FIG. 5C to equalize the pressure difference and remove the gripping suction.

The curved profile of the creased portions is advantageous so that the peripheral portion can collapse towards a retracted suction state without bulging or major lateral distortion. In addition the curved profile of the creased portions also provides a gradual or incremental resistance to the applied compressive force.

While the creased portion has a concave profile such that the groove opens away from the cylindrical axis, it will be appreciated that the creased portion can have a convex profile such that the groove opens towards the cylindrical axis without loss of generality.

In an example, the non-return valves are integrally formed on the peripheral portion. In another example, the non-return valves are mounted as attachment on the peripheral portion.

In an example, the flange members are or one of the flange members is integrally formed with the peripheral portion. In another example, the flange members are or one of the flange members is fastened to the peripheral portion by gluing, welding or other attachment means.

While the creased portions or grooves in the example of FIG. 1 have the same dimensions, it should be appreciated that the creased portions may have different dimensions without loss of generality. For example, the grooves may have different dimensions in the orientation of the creased portion plane. For example, the dimensions of the creased portion planes may gradually increased portion or gradually decreased portion to define a frustoconical or truncated conical shaped peripheral portion, or may have creased portion planes of alternate dimensions, or a combination thereof without loss of generality. Likewise, the axial length or the grooves may be different and the curvature of the grooves in the axial direction may also be different to suit applications or practical circumstances.

While the creased portions or grooves in the example of FIG. 1 are circular and collectively defines a cylinder or a substantial cylinder, it should be appreciated that the creased portion may have a non-circular outline such as a polygonal shape, especially a regular polygonal shape without loss of generality. Therefore, the term circumference herein is not limited to the boundary of a circle but can include boundary of a polygon such as a square, pentagon, hexagon etc.

In some embodiments, the peripheral portion may have a tulip shaped peripheral wall which is resiliently deformable transversely towards the internal compartment such that when the tulip shaped peripheral portion is so deformed, air inside the air-tight chamber will be driven out and create a low-pressure region to facilitate suctioning attachment. The tulip shaped peripheral wall may be bulge at about its axial middle portion to facilitate hand-grip deformation.

In some embodiments, the peripheral portion may comprise creased portions having gradually varying diameters or lateral extent. For example, a creased portion having the largest diameter may be positioned at axial middle, with the diameters of adjacent creased portions decreasing which moving axially away from the central crease portion.

In the above example, the first end of the article holder is for making suctioned engagement with a support surface while the second end is for making suctioned engagement with an article. Therefore, in one aspect, there is provided an article holder comprising a first end for coupling with a surface of an article, a second end for coupling with a support surface and a non-permeable body portion extending in an axial direction and interconnecting the first and second ends; wherein the first end is for entering into air-tight coupling with the surface of the article, the second end is for entry into air-tight coupling with the support surface, and the body portion is to expel air out of the volume between the article and the support surface when the body portion is compressed or squeezed to retract during use to form a low pressure region inside that volume whereby the article is held on the support surface by suction.

In another aspect, there is provided an article comprising a main body and a suction base for suctioned attachment to a supporting surface, the suction base comprising a first end in coupling with an end surface of the main body, a second end for coupling with a support surface and a non-permeable body portion extending in an axial direction and interconnecting the first and second ends; wherein the body portion is to expel air from the volume between the end surface and the support surface when compressed or squeezed to form a low pressure region inside that volume whereby the main body is suction attached to the support surface.

The main body may be detachable from the suction base and is to form an airtight coupling with the first end of the suction base during use.

It should be appreciated that the first and second ends can be interchangeably used without loss of generality. Furthermore, It should be appreciated that the disclosure and examples herein are to provide general illustration and are not to be construed to limit the scope of disclosure.

Table of Numerals

| | | | |
|---|---|---|---|
| 100 | Article holder | 10 | Beverage container |
| 110 | First end | 112 | First end flange |
| 120 | Second end | 122 | Second end flange |
| 130 | Peripheral portion | 131 | Depression |
| | | 132 | Creased portions |
| | | 133 | Circumferential rim |
| | | 134 | Non-return valve |
| 140 | Hollow compartment | | |

1-18. (canceled)

19. An article comprising a main body and a suction attachment device, wherein the suction attachment device comprises an attachment end for making suctioning attachment with a support surface and a peripheral portion interconnecting the attachment end and the main body, and wherein the suction attachment device is to form an air-tight chamber when in cooperation with the support surface during use, and the peripheral portion is deformable to expel air out of the air-tight chamber thorough an air exit arrangement on the peripheral portion to form a low pressure region inside the air-tight chamber to facilitate making of suctioning attachment with the support surface.

20. The article according to claim 19, wherein the main body is a container and the suction attachment device is releasable or detachable from the main body.

21. The article according to claim 19, wherein the air exit arrangement is formed on the peripheral portion and comprises one or a plurality of non-return valves or one-way valves to facilitate removal of air from the air-tight chamber to form the low-pressure region and to restrict or prevent moving of air into the air-tight chamber from outside.

22. The article according to claim 21, wherein the non-return valves or the one-way valves are distributed around and/or along the air-tight chamber.

23. The article according to claim 19, wherein the peripheral portion extends between the first and the second end in an axial direction, the peripheral portion being resiliently deformable in the axial direction and/or in a direction transverse to the axial direction to change volume of the air-tight chamber.

24. The article according to claim 19, wherein the peripheral portion is to define a low-pressure chamber during use when squeezed or compressed to reduce the volume of the air-tight chamber.

25. The article according to claim 19, wherein the peripheral portion is resiliently urged to expand from a retracted state defining the low-pressure region to an expanded state where pressure inside the air-tight chamber is equalized or substantially equalized with pressure outside the air-tight chamber.

26. The article according to claim 19, wherein the peripheral portion includes at least one resilient bellows-shaped member or a plurality of resilient bellows-shaped members forming an aligned stack of resilient bellows-shaped members, and wherein the resilient bellows-shaped member is to contract to reduce its height when subject to an axial compressive force to reduce volume of the air-tight chamber to form the low-pressure region and the bellows-shaped member is resiliently urged to expand axially upon removal of the compressive force.

27. The article according to claim 19, wherein volume of the air-tight chamber is defined by a peripheral wall of the peripheral portion which surrounds the air-tight chamber, and the air exit arrangement is integrally formed on the peripheral wall.

28. The article according to claim 27, wherein the peripheral wall has a thickness that is higher at the air exit arrangement and lower at locations away from the air exit arrangement.

29. The article according to claim 27, wherein thickness of the peripheral wall gradually decreases on moving away from the air exit arrangement.

30. The article according to claim 27, wherein thickness of the peripheral wall is between 0.17 mm and 0.3 mm.

31. The article according to claim 19, wherein the first end, the second end and/or the attachment end are/is formed as a resilient sealing device to seal the air-tight chamber during use.

32. The article according to claim 19, wherein the article holder is integrally formed of a resilient material such as soft plastics, rubber, silicone rubber or polypropylene.

33. An article holder comprising a first end, a second end, and a peripheral portion interconnecting the first end and the second end, wherein the first end is for attaching to a support surface to form a first air-tight end, the second end is for attaching to a surface of an article to form a second air-tight end, and the peripheral portion is to form an air-tight chamber in cooperation with the first and second air-tight ends during use; and wherein the peripheral portion is deformable to expel air from the air-tight chamber thorough an air exit arrangement on the peripheral portion to form a low-pressure region inside the air-tight chamber to facilitate suctioned attachment of the article to the support surface via the article holder.

34. The article holder according to claim 33, wherein the first end is formed as a resilient receptacle to provide an air-tight seat for engaging with the surface of the article.

35. The article holder according to claim 33, wherein the first end is formed into a receptacle for closely fitted reception of the bottom end of a disposable container such as a disposal cup or a disposable bowl.

36. The article holder according to claim 33, wherein the air exit arrangement is formed on the peripheral portion and comprises one or a plurality of non-return valves or one-way valves to facilitate removal of air from the air-tight chamber to form the low-pressure region and to restrict or prevent moving of air into the air-tight chamber from outside.

37. The article holder according to claim 33, wherein the non-return valves or the one-way valves are distributed around and/or along the air-tight chamber.

38. The article holder according to claim 33, wherein the peripheral portion includes at least one resilient bellows-shaped member or a plurality of resilient bellows-shaped members forming an aligned stack of resilient bellows-shaped members, and wherein the resilient bellows-shaped member is to contract to reduce its height when subject to an axial compressive force to reduce volume of the air-tight chamber to form the low-pressure region and the bellows-shaped member is resiliently urged to expand axially upon removal of the compressive force.
